(19) United States
(12) Patent Application Publication
(10) Pub. No.: US 2023/0385325 A1
(43) Pub. Date: Nov. 30, 2023

(54) INFORMATION PROCESSING DEVICE, INFORMATION PROCESSING METHOD, AND PROGRAM

(71) Applicant: SONY GROUP CORPORATION, TOKYO (JP)

(72) Inventors: SHIN TAKANASHI, TOKYO (JP); YU SHIGETA, TOKYO (JP)

(21) Appl. No.: 18/249,745

(22) PCT Filed: Oct. 15, 2021
(86) PCT No.: PCT/JP2021/038169

§ 371 Date: Apr. 20, 2023

(30) Foreign Application Priority Data
Oct. 29, 2020 (JP) 2020-181002

(51) Int. Cl. G06F 16/35; G06F 3/0484; G06Q 50/00

(52) U.S. Cl. CPC G06F 16/358; G06Q 50/01; G06F 3/0484

(57) ABSTRACT

The present technology relates to an information processing device, an information processing method, and a program capable of drawing out the user's creativity. An information processing device includes a user interface control unit that receives posting of a root issue that is a question to be solved and a related question that is a question related to the root issue, and controls display of the root issue and the related question. The present technology can be applied to, for example, a system that solves a user's problem, question, or the like.

### TECHNICAL FIELD

The present technology relates to an information processing device, an information processing method, and a program, and more particularly, to an information processing device, an information processing method, and a program capable of drawing out the user's creativity.

### BACKGROUND ART

With the recent progress of the information society, access to external information is becoming easier every day. As a result, the user can easily obtain answers to various questions.

Furthermore, conventionally, an information processing device that responds to a question from a user not only with the answer but also with information adapted to the user has been proposed (see Patent Document 1, for example).

### CITATION LIST

### Patent Document

Patent Document 1: Japanese Patent Application Laid-Open No. 2015-133047

### SUMMARY OF THE INVENTION

### Problems to be Solved by the Invention

However, as the opportunity of accessing external information increases, the user tends to be attracted by external values. Therefore, the opportunity for the user to access and organize his/her own thought is reduced, and there is a possibility that it actually becomes difficult to draw out the user's own creativity.

The present technology has been made in view of such a situation, and aims to draw out the user's creativity.

Solutions to Problems

An information processing device according to one aspect of the present technology includes a user interface control unit that receives posting of a root issue that is a question to be solved and a related question that is a question related to the root issue, and controls display of the root issue and the related question.

An information processing method according to one aspect of the present technology includes receiving posting of a root issue that is a question to be solved and a related question that is a question related to the root issue, and controlling display of the root issue and the related question.

A program according to one aspect of the present technology includes receiving posting of a root issue that is a question to be solved and a related question that is a question related to the root issue, and controlling display of the root issue and the related question.

In one aspect of the present technology, posting of a root issue that is a question to be solved and a related question that is a question related to the root issue is received, and display of the root issue and the related question is controlled.

### BRIEF DESCRIPTION OF DRAWINGS

FIG. 1 is a block diagram illustrating a configuration example of an information processing system to which the present technology is applied.

FIG. 2 is a block diagram illustrating a configuration example of a server.

FIG. 3 is a block diagram illustrating a configuration example of a user terminal.

FIG. 4 is a diagram illustrating an example of a thread search screen.

FIG. 5 is a diagram illustrating details of a thread information field.

FIG. 6 is a diagram illustrating an example of detailed display of a thread.

FIG. 7 is a diagram illustrating an example of detailed display of a thread.

FIG. 8 is a diagram illustrating a display example of a tree diagram.

FIG. 9 is a diagram illustrating a display example of nodes in a tree diagram.

FIG. 10 is a diagram illustrating a display example of an individual display field of a related question.

FIG. 11 is a diagram illustrating a display example of an individual display field of a related question.

FIG. 12 is a diagram illustrating a display example of an individual display field of a related question.

FIG. 13 is a diagram illustrating a display example of an individual display field of a root issue.

FIG. 14 is a diagram illustrating a display example of an individual display field of a root issue.

FIG. 15 is a diagram illustrating an example of detailed display of a thread at the time of solving a root issue.

FIG. 16 is a diagram illustrating a configuration example of a thread DB.

FIG. 17 is a diagram illustrating a configuration example of node data of a thread DB.

FIG. 18 is a diagram illustrating a configuration example of branch data of a thread DB.

FIG. 19 is a diagram illustrating a configuration example of a user DB.

FIG. 20 is a flowchart for describing automatic response processing.

### MODES FOR CARRYING OUT THE INVENTION

Hereinafter, modes for carrying out the present technology will be described. The description will be given in the following order.

1. Background of Present Technology

2. Embodiment

3. Modification

4. Other

### 1. Background of Present Technology

For example, in a case where a person consults about a problem, the person who receives the consultation may not find a clear solution and may only repeat a quick response or a question. On the other hand, even if a solution is not particularly given, there is a case where the consulter naturally organizes his/her own thought and can derive the solution by himself/herself while talking about his/her problems or answering questions. This process is, for example, a process similar to coaching or behavioral psychology.

Against this background, the present technology enables the user to draw out his/her own creativity by providing a platform that returns a question to the user's question.

### 2. Embodiment

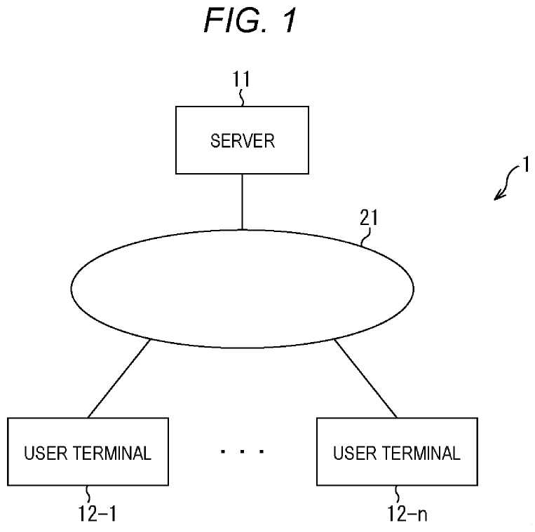

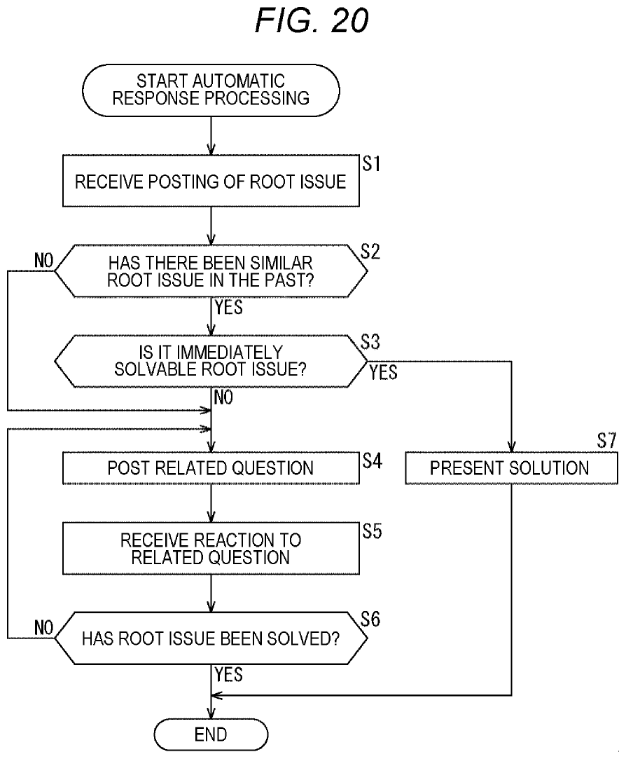

Next, an embodiment of the present technology will be described with reference to FIGS. 1 to 20.

<Configuration Example of Information Processing System 1>

FIG. 1 illustrates a configuration example of an information processing system 1 to which the present technology is applied.

The information processing system 1 is a system that provides a Q & Q service.

The Q & Q service is a service that provides the user with a platform that returns a question to the user's question.

For example, when the user posts a question to be solved, another user or a server 11 posts a question to the user's question. In response to this, the user posts an answer or a question to the question from the other user or the server 11. Moreover, the other user or the server 11 posts a question to a question from the user, the other user, or the server 11, or an answer from the user. In response to this, the user posts an answer or a question to the question from the other user or the server 11. As described above, the Q & Q service is a service that allows the user himself/herself to derive an answer to a root issue by repeating processing in which another user or the server 11 asks a question posted by the user and the user answers or asks a question to the question.

Note that hereinafter, a question that the user first posts and finally solves is referred to as a root issue. Hereinafter, a question related to the root issue is referred to as a related question. Related questions include not only questions posted directly to the root issue, but also questions posted indirectly to the root issue. A question indirectly posted to the root issue is a question two or more hierarchies away from the root issue, such as a question for a question directly posted to the root issue.

Note that the contents of the root issue are not particularly limited as long as the root issue is a question that the user wants to solve. For example, the root issue includes user's problems, questions, concerns, and the like.

Furthermore, hereinafter, a group including a root issue, a related question related to the root issue, an answer to the root issue, and an answer to the related question is referred to as a thread. Hereinafter, the user who has posted the root issue is referred to as an owner. Therefore, the owner who posted the root issue is also the owner of the thread including the root issue. Hereinafter, a user other than the owner of the thread is referred to as a general user in the thread. Therefore, in a thread, users other than the user who has posted the root issue are general users.

Furthermore, hereinafter, an answer to a root issue is referred to as a solution and an answer to a related question is referred to as a reply. This is because an answer to a root issue is often derived by the user, and an answer to a related question is often a reply to a question. Note, however, that the difference between the two is not necessarily strict, and the two have similar meanings in some cases.

The information processing system 1 includes the server 11 and user terminals 12-1 to 12-n. The server 11 and the user terminals 12-1 to 12-n are connected to each other via a network 21.

Note that hereinafter, in a case where it is not necessary to individually distinguish the user terminals 12-1 to 12-n, they are simply referred to as the user terminal 12.

The server 11 is an information processing device that performs various types of information processing for the user to use the Q & Q service using the user terminal 12.

The user terminal 12 is an information processing terminal used by a user who uses the Q & Q service, and includes, for example, a smartphone, a tablet terminal, a mobile phone, a personal computer (PC), or the like. Note that one user can use a plurality of user terminals 12.

<Configuration Example of Server 11>

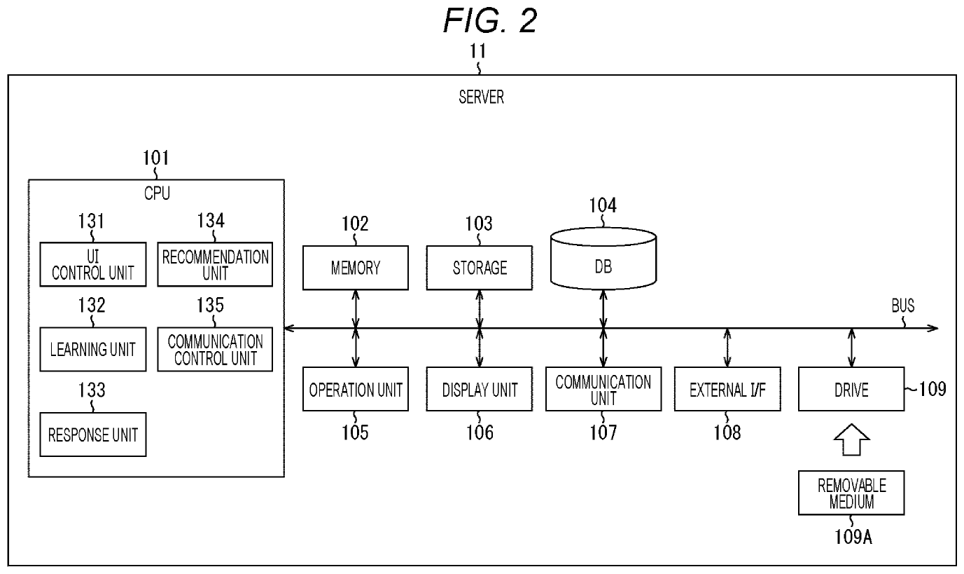

FIG. 2 is a block diagram illustrating a functional configuration example of the server 11 of FIG. 1.

The server 11 includes a central processing unit (CPU) 101, a memory 102, a storage 103, a data base (DB) 104, an operation unit 105, a display unit 106, a communication unit 107, an external interface (I/F) 108, and a drive 109. The CPU 101 to the drive 109 are connected to a bus and perform necessary communication with each other.

The CPU 101 performs various types of processing by executing programs installed in the memory 102 and the storage 103.

The memory 102 includes, for example, a volatile memory or the like, and temporarily stores a program executed by the CPU 101 and necessary data.

The storage 103 includes, for example, a hard disk or a nonvolatile memory, and stores a program executed by the CPU 101 and necessary data.

The DB 104 is a database that stores various types of data related to the Q & Q service. For example, the DB 104 includes a thread database (DB) that stores data regarding each thread in the Q & Q service. Furthermore, for example, the DB 104 includes a user database (DB) that stores data regarding a user who uses the Q & Q service.

The operation unit 105 includes physical keys (including keyboard), a mouse, a touch panel, and the like. According to a user operation, the operation unit 105 outputs an operation signal corresponding to the operation to the bus.

The display unit 106 includes, for example, a liquid crystal display (LCD) or the like, and displays an image according to data supplied from the bus.

Here, for example, the touch panel as the operation unit 105 includes a transparent member and can be integrally formed with the display unit 106. As a result, the user can input information by operating an icon, a button, or the like displayed on the display unit 106.

The communication unit 107 includes a communication circuit, an antenna, and the like, and communicates with the user terminal 12 via the network 21 or not via the network 21.

The external I/F 108 is an interface for exchanging data with various external devices.

The drive 109 can attach and detach a removable medium 109A such as a memory card, for example, and drives the removable medium 109A attached thereto.

In the server 11 configured as described above, a program executed by the CPU 101 can be recorded in advance in the storage 103 as a recording medium built in the CPU 101.

Furthermore, the program can be stored (recorded) in the removable medium 109A, provided as so-called package software, and be installed from the removable medium 109A to the server 11.

In addition, the program can be downloaded from a server (not illustrated) or the like via the network 21 and the communication unit 107 and be installed in the server 11.

The CPU 101 executes a program installed in the server 11 to implement functions including a user interface (UI) control unit 131, a learning unit 132, a response unit 133, a recommendation unit 134, and a communication control unit 135.

The UI control unit 131 communicates with the user terminal 12 via the communication unit 107 and the network 21, and controls a user interface of the Q & Q service in the user terminal 12.

The learning unit 132 performs various types of learning processing related to the Q & Q service using, for example, an arbitrary machine learning method. For example, the learning unit 132 learns the feature of each user. For example, the learning unit 132 learns the feature of each thread.

The response unit 133 automatically generates and posts related questions for the root issue and related questions as necessary. Furthermore, the response unit 133 automatically generates and posts a solution to the root issue as necessary.

The recommendation unit 134 recommends another user to be followed by the user on the basis of the characteristics of the user or the like as necessary.

The communication control unit 135 controls communication by the communication unit 107.

Note that hereinafter, in a case where each unit of the server 11 performs communication and the like with the user terminal 12 via the communication unit 107 and the network 21, description of “via the communication unit 107 and the network 21” will be omitted. For example, in a case where the UI control unit 131 communicates with the user terminal 12 via the communication unit 107 and the network 21, it is simply described that the UI control unit 131 communicates with the user terminal 12.

<Configuration Example of User Terminal 12>

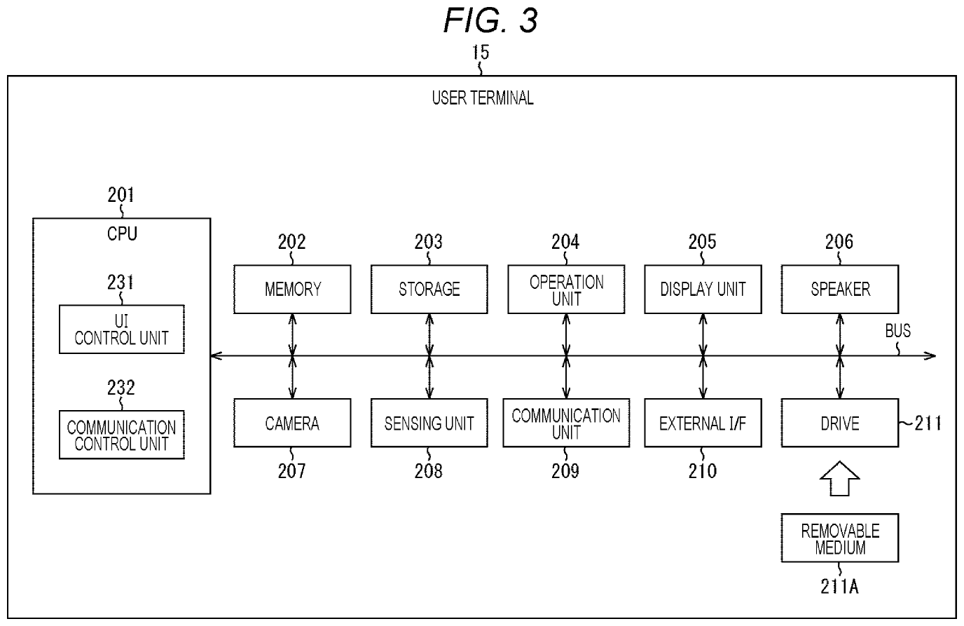

FIG. 3 is a block diagram illustrating a functional configuration example of the user terminal 12.

The user terminal 12 includes a CPU 201, a memory 202, a storage 203, an operation unit 204, a display unit 205, a speaker 206, a camera 207, a sensing unit 208, a communication unit 209, an external I/F 210, and a drive 211. The CPU 201 to the drive 211 are connected to a bus and perform necessary communication with each other.

The CPU 201 to the storage 203, the operation unit 204, the display unit 205, and the communication unit 209 to the drive 211 are configured similarly to the CPU 101 to the storage 103, the operation unit 105, the display unit 106, and the communication unit 107 to the drive 109 in FIG. 2, respectively.

The speaker 206 outputs sound according to data supplied from the bus.

The camera 207 captures an image (still image, moving image) (senses light) and outputs corresponding image data to the bus.

The sensing unit 208 includes various sensors, and outputs sensor data output from each sensor to the bus. The sensing unit 208 includes, for example, a global navigation satellite system (GNSS) receiver, an acceleration sensor, an angular velocity sensor, and the like.

In the user terminal 12, similarly to the server 11, a program executed by the CPU 201 can be recorded in advance in the storage 203 as a recording medium built in the user terminal 12.

Furthermore, the program can be stored (recorded) in a removable medium 211A, provided as package software, and be installed from the removable medium 211A to the user terminal 12.

In addition, the program can be downloaded from a server (not illustrated) or the like via the network 21 and the communication unit 209 and be installed in the user terminal 12.

The CPU 201 executes a program installed in the user terminal 12 to implement functions including a user interface (UI) control unit 231 and a communication control unit 232.

The UI control unit 231 controls a user interface using the display unit 205, the speaker 206, and the like.

The communication control unit 232 controls communication by the communication unit 209.

Note that hereinafter, in a case where each unit of the user terminal 12 communicates with the server 11 via the communication unit 209 and the network 21, description of “via the communication unit 209 and the network 21” will be omitted. For example, in a case where the UI control unit 231 communicates with the server 11 via the communication unit 209 and the network 21, it is simply described that the UI control unit 231 communicates with the server 11.

<Q & Q Service User Interface>

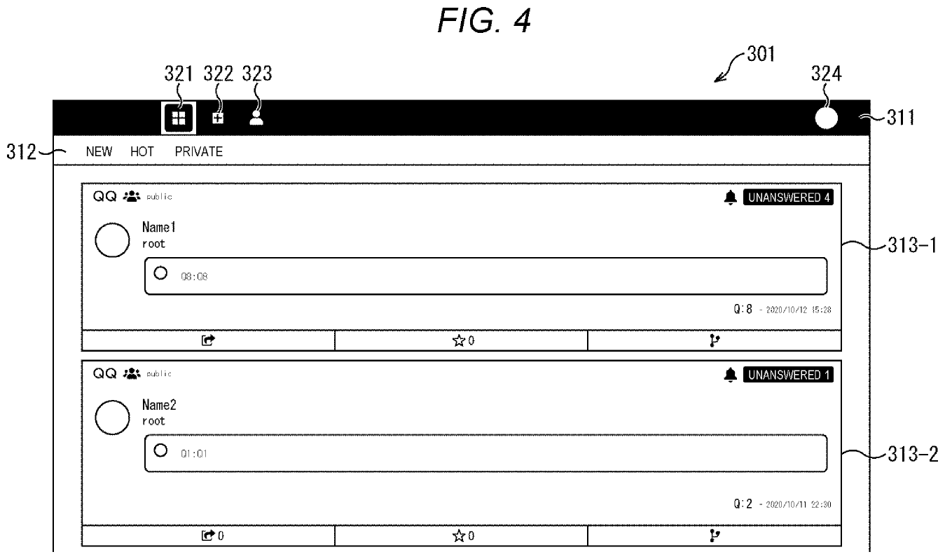

Next, a specific example of a user interface of the Q & Q service provided by the server 11 will be described with reference to FIGS. 4 to 15.

Note that FIGS. 4 to 15 illustrate examples of screens displayed on the display unit 106 of the user terminal 12 in a case where the Q & Q service is used. These display screens are displayed on the display unit 205 of the user terminal 12 under the control of the UI control unit 131 of the server 11 and the UI control unit 231 of the user terminal 12.

FIG. 4 illustrates an example of a search screen of a thread of the Q & Q service. A window 301 is displayed on this search screen.

A tool bar 311 and a menu bar 312 are displayed at the upper end of the window 301.

Buttons 321 to 323 and thumbnails 324 are displayed on the tool bar 311.

The button 321 is a button for displaying a search screen for searching for a thread. Note that FIG. 4 illustrates an example of a screen when the button 321 is pressed.

The button 322 is a button for posting a root issue and starting a new thread. When the button 322 is pressed, a root issue input screen is displayed. Then, when the root issue is input and posted, a thread including the posted root issue is generated.

The button 323 is a button for displaying a profile screen of the user. When the button 323 is pressed, a profile screen is displayed. For example, the user's name or nickname, thumbnail, self-introduction text, followees, followers, and the like are displayed on the profile screen.

A followee is another user followed by the user. The user can basically receive questions from followees in a thread created by the user. On the other hand, the user basically cannot receive questions from users other than followees in the thread created by the user. That is, posting of questions from users other than followees is restricted.

A follower is another user following the user. The user can basically post questions to threads created by followers. On the other hand, the user basically cannot post questions to threads created by users other than followers. That is, posting of questions to threads created by users other than followers is restricted.

Furthermore, the user can edit his/her profile or follow other users on the profile screen.

The thumbnail 324 is a thumbnail including a user's face image or the like.

The menu bar 312 displays items “new”, “hot”, and “private”.

When “new” is selected, a new thread is displayed in the window 301. For example, a new root issue is posted, and a list of launched threads is displayed in the window 301 with the newest post at the top.

When “hot” is selected, a thread attracting much attention is displayed in the window 301. For example, a list of threads having a large number of views is displayed in the window 301 in descending order of the number of views. Alternatively, for example, a list of threads having a large number of posts is displayed in the window 301 in descending order of the number of posts.

When “private” is selected, for example, a list of threads not open to the public among the threads created by the user is displayed in the window 301.

Thread information fields 313-1, 313-2, . . . are displayed in the window 301. Note that hereinafter, in a case where it is not necessary to individually distinguish the thread information fields 313-1, 313-2, . . . , they are simply referred to as the thread information field 313.

Each thread information field 313 corresponds to one thread and displays information regarding the corresponding thread.

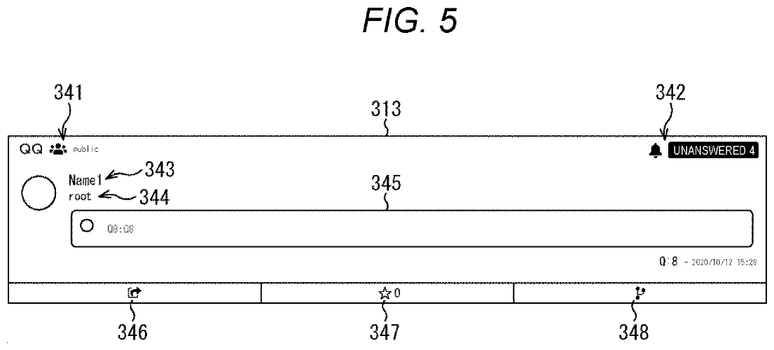

Here, details of the thread information field 313 will be described with reference to FIG. 5.

Disclosure range information 341 is displayed in the upper left corner of the thread information field 313. The disclosure range information 341 includes an icon and characters indicating the disclosure range of the thread. The disclosure range of a thread is selected from, for example, three types of full disclosure (public), non-disclosure (secret), and limited disclosure (group).

Unanswered information 342 is displayed in the upper right corner of the thread information field 313. The unanswered information 342 includes the number of unanswered related questions among related questions in a thread, and the like.

Owner information 343 is displayed below the disclosure range information 341. The owner information 343 includes the name or nickname of an owner of a thread and a thumbnail (indicated by circle in FIG. 5).

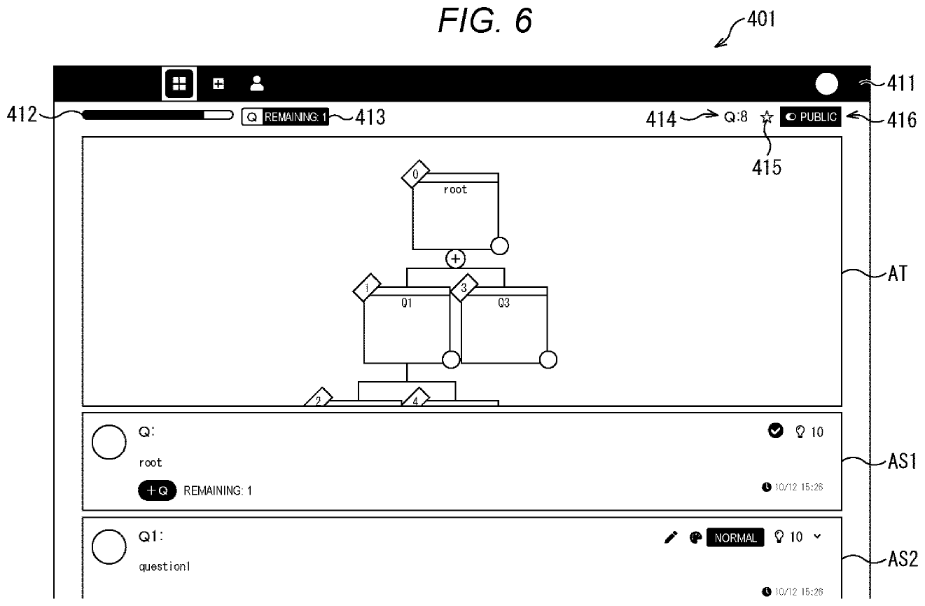

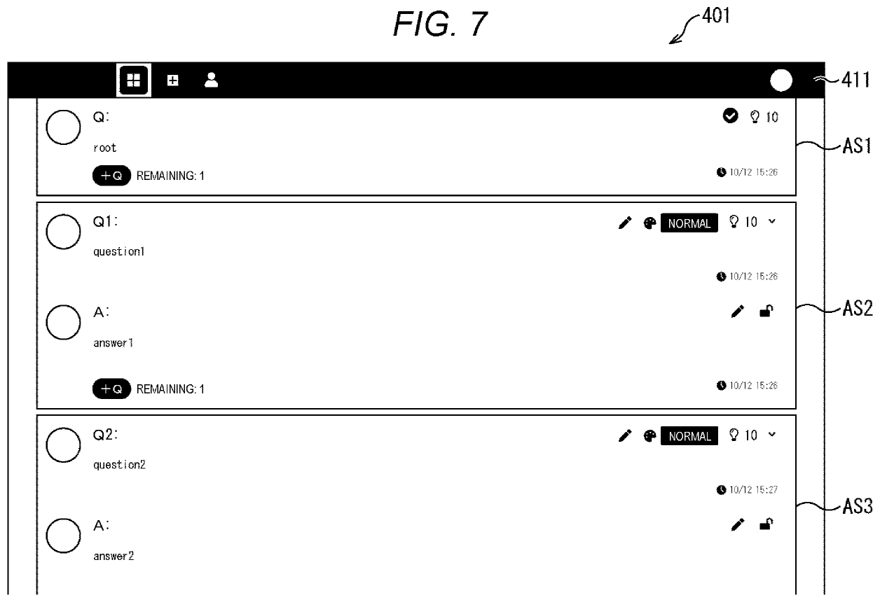

A link 344 including the characters “root” is displayed at the lower right of the owner information 343. When the link 344 is pressed, details of the thread are displayed as described later with reference to FIGS. 6 and 7.

A horizontally extending latest post information field 345 is displayed under the owner information 343 and the link 344. Contents of the latest post in the thread is displayed in the latest post information field 345. Specifically, text of the latest post among related questions and replies posted in the thread is displayed. Furthermore, a thumbnail (indicated by circle in FIG. 5) of the user who has posted the latest related question or reply, and a question number or a reply number are displayed. The date and time of the latest post is displayed at the lower right of the latest post information field 345.

Here, questions in a thread are assigned serial numbers (question numbers) in the posted order. That is, zero is assigned as the question number of the root issue, and thereafter, one or a larger serial numbers is assigned to each related question in the posted order. Furthermore, a reply number of the same number as the question number of the related question is assigned to the reply to the related question.

A citation retweet button 346, a bookmark button 347, and a history button 348 are displayed at the lower end of the thread information field 313.

The citation retweet button 346 is a button for using a citation retweet function. The citation retweet function is a function of citing a root issue of another user, posting the root issue, and starting a new thread. For example, when the citation retweet button 346 is pressed, a screen for posting a root issue that cites the root issue of the thread displayed in the thread information field 313 is displayed.

The bookmark button 347 is a button for using a bookmark function. The bookmark function is a function that allows the user to store a favorite thread and browse the thread on a dedicated page or the like of the user. For example, when the bookmark button 347 is pressed, a thread displayed in the thread information field 313 is registered in the bookmark. The number in the bookmark button 347 indicates how many threads displayed in the thread information field 313 are bookmarked.

The history button 348 is a button for using a history function. The history function is a function of displaying a correlation between a root issue of a thread and a root issue of another thread in the thread information field 313. That is, it is a function of displaying a relationship with another root issue cited by the root issue of the thread in the thread information field 313 and a relationship with another root issue that cites the root issue of the thread in the thread information field 313. For example, when the history button 348 is pressed, root issues related to the root issue of the thread in the thread information field 313 are displayed in a tree shape.

For example, when the link 344 in the thread information field 313 is pressed, a window 401 illustrated in FIGS. 6 and 7 is displayed. Note that a window 401 in FIG. 7 illustrates a state in which the window 401 in FIG. 6 is scrolled downward.

A tool bar 411 similar to the tool bar 311 of the window in FIG. 4 is displayed at the upper end of the window 401.

A progress bar 412 and a button 413 are displayed side by side at the lower left of the tool bar 411.

The progress bar 412 indicates the use rate of an unanswered question frame.

Here, the unanswered question frame is an upper limit value of the number of related questions that can be left unanswered in a thread. For example, in a case where the unanswered question frame is set to five, when the number of unanswered related questions in a thread reaches five, posting of new related questions to the thread is restricted. For example, posting of new related questions is prohibited until the number of unanswered related questions is less than the unanswered question frame.

For example, in a case where the unanswered question frame is set to five and the number of unanswered related questions in a thread is four, the value of the progress bar 412 will be 80%.

The button 413 is used to select an unanswered related question in the thread. Every time the button 413 is pressed, a state in which an unanswered related question is selected and a state in which an unanswered related question is not selected are switched.

Furthermore, the remaining number of unanswered question frames is displayed in the button 413. For example, in a case where the unanswered question frame is set to five and the number of unanswered related questions in a thread is four, one, which is the remaining number of the unanswered question frame, is displayed.

The number of questions 414, a bookmark button 415, and a public button 416 are displayed at the lower right of the tool bar 411.

The number of questions 414 indicates the total number of questions (root issues and related questions) in the thread.

The bookmark button 415 is used to register a thread in a bookmark. That is, when the bookmark button 415 is pressed, a thread in the window 401 is registered in a bookmark of the user who is displaying the thread.

The public button 416 is used to change the disclosure range of a thread. Every time the public button 416 is pressed, the disclosure range of the thread is switched between full disclosure and non-disclosure. Furthermore, whether or not the thread is open to the public is displayed in the public button 416.

Note that the public button 416 is displayed only on the screen for the owner, for example.

In the window 401, a thread including the selected root issue is displayed in two types of forms of tree display and individual display.

The tree display is a format in which a hierarchical structure of questions in a thread is displayed in a tree shape.

The individual display is a format of individually displaying details of a question selected in the tree display among the questions in the thread.

Specifically, in the window 401, a tree display field AT, an individual display field AS1, an individual display field AS2, an individual display field AS3, . . . are displayed next to one another in the vertical direction.

Note that hereinafter, in a case where it is not necessary to individually distinguish the individual display fields AS1, AS2, AS3 . . . , they are simply referred to as the individual display field AS.

In the tree display field AT, a thread is displayed in a tree shape. Specifically, a tree diagram representing the hierarchical structure of the root issue and the related questions in the thread in a tree shape in a bird's eye view is displayed.

On the other hand, each individual display field AS displays the root issue and the related questions in the thread individually. Specifically, individual display fields AS indicating details of the question (root issue or related question) of a node selected in the tree diagram are individually displayed next to one another in the vertical direction. The number of individual display fields AS to be displayed increases or decreases in accordance with the number of nodes (questions) selected in the tree diagram.

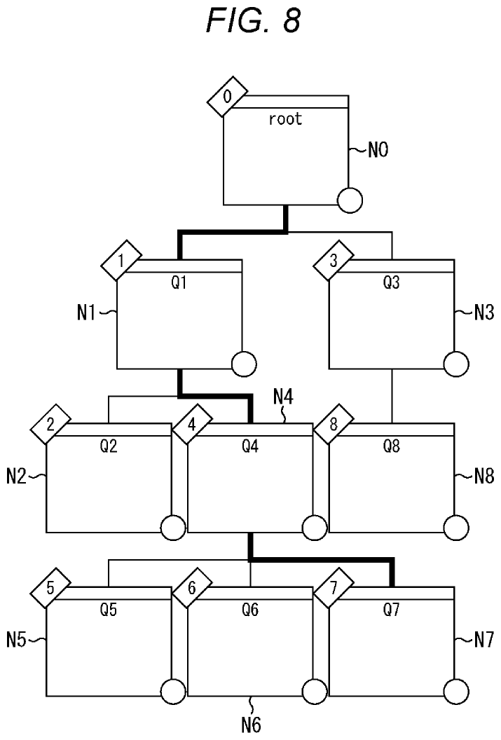

FIG. 8 illustrates details of the tree diagram displayed in the tree display field AT.

The tree diagram is a diagram in which nodes representing each question (root issue or related question) are displayed hierarchically in the vertical direction, and nodes of questions in a parent-child relationship are connected by links. In this example, questions are represented by nodes N0 to N8.

The highest node N0 in the tree diagram is a node of the root issue. Hereinafter, a node of a root issue is referred to as a root node.

Furthermore, hereinafter, among nodes in a parent-child relationship, a higher node is referred to as a parent node, and a lower node is referred to as a child node. In other words, in the tree diagram, among nodes arranged in different hierarchies and connected by a link, a higher node is referred to as a parent node, and a lower node is referred to as a child node. Therefore, a question posted to a question of a parent node is a question of a child node.

For example, node N0, node N1, and node N3 are in a parent-child relationship, where node N0 is a parent node and node N1 and node N3 are child nodes. Therefore, the question posted to the question (root issue) of node N0 is the question (related question) of node N1 and node N3.

Furthermore, node N1, node N2, and node N4 are in a parent-child relationship, where node N1 is a parent node and node N2 and node N4 are child nodes. Therefore, the question posted to the question (related question) of node N1 is the question (related question) of node N2 and node N4.

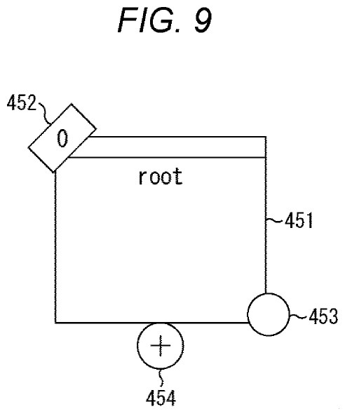

FIG. 9 illustrates details of a node. A node includes a main body 451, a number field 452, a thumbnail 453, and a button 454.

The main body 451 is designed to represent a rectangular tag. Although not illustrated in this example, a text indicating the contents of the question is displayed on the main body 451. Note that, for example, the main body 451 of a root node and the main body 451 of another node are displayed in different display modes (e.g., different colors).

The number field 452 is displayed in the upper left corner of the main body 451, and the question number of a question displayed on the main body 451 is displayed in the number field 452. Note that hereinafter, the question number displayed in the number field 452 is also referred to as a node number.

The thumbnail 453 is a thumbnail representing the user (hereinafter referred to as questioner) who has posted the question, and is displayed at the lower right corner of main body 451. Note that the thumbnail 453 of the root node is a thumbnail of the owner who is the questioner of the root issue.

For example, the display mode of the thumbnail 453 of a node of the related question is different between a node of an unanswered related question and a node of an answered related question. For example, the periphery of the thumbnail 453 of a node of an answered related question is emphasized with a red frame. On the other hand, the periphery of the thumbnail 453 of a node of an unanswered related question is not particularly emphasized.

The button 454 is displayed below the main body 451 of the selected node in the tree diagram. The button 454 is used to input a related question or a reply to the question displayed in the main body 451.

For example, in a case where the root node is selected on the screen of the owner of the thread or a general user, the button 454 for inputting a question for the root issue is displayed. When the button 454 is pressed, a question input field or the like is displayed.

For example, in a case where a node of an unanswered related question is selected on the screen of the owner of the thread, the button 454 for inputting a reply to the selected related question is displayed. When the button 454 is pressed, a reply input field or the like is displayed.

On the other hand, in a case where a node of an unanswered related question is selected on the screen of a general user, the button 454 is not displayed.

Furthermore, in a case where a node of an answered related question is selected on the screen of the owner of the thread and a general user, the button 454 for inputting a related question for the selected related question is displayed.

Therefore, any user can post a related question to a root issue and an answered related question. On the other hand, all users are restricted from posting a related question to an unanswered related question. That is, no user can post a related question to an unanswered related question. Furthermore, the owner can post a reply to a related question. On the other hand, a general user is restricted from posting a reply to a related question except for a special case to be described later. That is, a general user cannot post a reply to a related question except for a special to be described later.

Note that the display mode (such as color) of the button 454 is different between a case of being used as a reply input button and a case of being used as a question input button.

For example, when an arbitrary node other than the root node is selected in the tree diagram, the individual display fields AS indicating details of related questions of the selected node are displayed below the tree display field AT in the window 401. Furthermore, in the tree diagram, a selected node has a display mode different from other nodes. For example, colors of the main body 451 and the number field 452 of the selected node become dark. Moreover, a link from the root node to the selected node is emphasized. For example, the link becomes thick.

On the other hand, when the root node is selected in the tree diagram, the individual display fields AS indicating details of all the questions in the thread are displayed below the tree display field AT in the window 401 next to one another in the vertical direction in the order of the question number (chronological order).

Furthermore, when an arbitrary link is selected in the tree diagram, the individual display fields AS indicating details of questions of nodes on a path from the root node to a lower node among nodes connected to the selected link are displayed below the tree display field AT in the window 401 next to one another in the vertical direction in the order of the question number (chronological order). Furthermore, in the tree diagram, links on the path described above are emphasized.

For example, when a link between node N4 and node N7 is selected, the individual display fields AS indicating details of questions of nodes on a path from node N0 as the root node to node N7 are displayed in the order of the node number (question number). Specifically, the individual display fields AS indicating details of questions of node N0, node N1, node N4, and node N7 are displayed next to one another in the vertical direction in the order of the node number. Furthermore, as illustrated in FIG. 8, links on a path from node N0 to node N8 are emphasized in the tree diagram.

For example, any user can collectively select nodes of unanswered related questions in a thread by operating the button 413 in FIG. 8. When a node of an unanswered related question is selected, the individual display fields AS indicating details of each unanswered related question are displayed below the tree display field AT in the window 401 next to each other in the vertical direction in the order of the question number (chronological order).

As described above, the owner and a general user can select an arbitrary node in the tree diagram and individually display details of questions of the selected node.

Note that in the tree diagram, the intervals and positions of the nodes are adjusted according to the number of nodes in each hierarchy. As a result, each node is appropriately arranged, and visibility is improved.

Furthermore, in the tree diagram, the contents of replies related to each related question are not displayed, and only the relationship between the root issue and each related question is displayed.

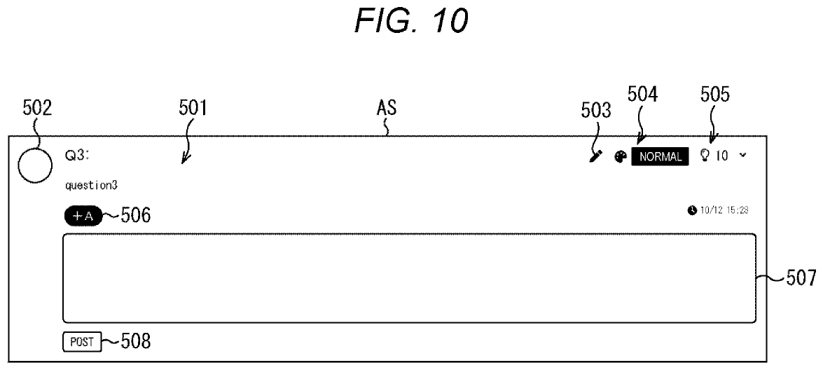

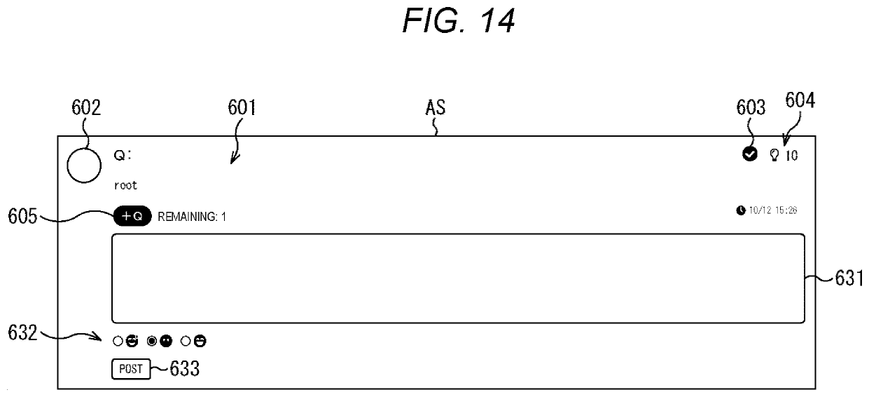

Next, an example of display contents of the individual display field AS will be described with reference to FIGS. 10 and 14.

FIGS. 10 to 12 illustrate examples of display contents of the individual display field AS corresponding to a related question on the screen of the owner.

FIG. 10 illustrates an example of display contents of the individual display field AS at the time of inputting a reply to the related question.

In an area 501 of the individual display field AS, information regarding the related question is displayed. Specifically, a question number is displayed in the upper left corner of the area 501. Although not illustrated, a text indicating the contents of the related question is displayed with the position where characters “question 3” are displayed in the area 501 as the head. The posted date and time of the related question is displayed in the lower right corner of the area 501.

A thumbnail 502 (indicated by circle in FIG. 10) representing the questioner of the related question is displayed in the upper left corner of the individual display field AS.

Buttons 503 to 505 are displayed in the upper right corner of the individual display field AS.

The button 503 is a button for editing the related question. When the button 503 is pressed, the related question displayed in the area 501 becomes editable. Note that the button 503 is enabled only on the screen of the questioner, for example.

The button 504 is a button for evaluating the related question in the individual display field AS. As will be described later, the owner can give three types of ratings of “normal”, “important”, and “review” to the related question in the individual display field AS. The rating of each related question is set to “normal” by default.

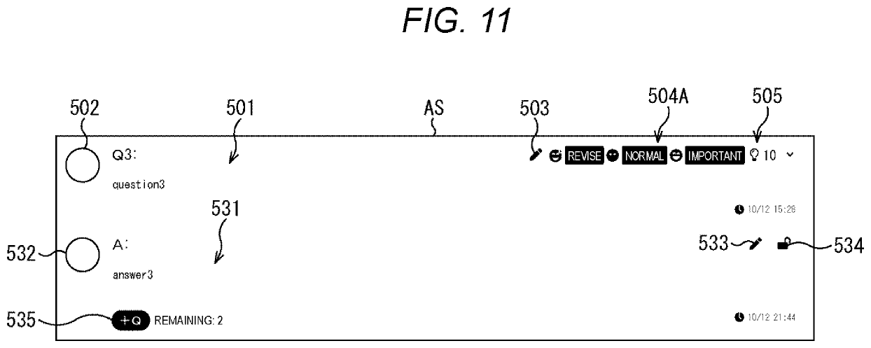

The button 504 displays the current rating of the related question in the individual display field AS. Furthermore, when the button 504 is pressed, as will be described later with reference to FIG. 11, it is possible to input a rating of the related question. The same applies to a case where the button 454 (FIG. 9) of a node of a related question in the individual display field AS is pressed in the tree diagram.

The button 505 is a button for giving a high rating (such as like) to the related question in the individual display field AS. For example, in a case where a general user thinks that a related question in the individual display field AS is good or empathizes with the related question, the general user can give a high rating to the related question by pressing the button 505. Note that the number in the button 505 indicates the number of users who have given a high rating.

A button 506 is displayed at the lower left of the area 501. The button 506 is a button for inputting a reply to a related question in the individual display field AS. When the button 506 is pressed, an input field 507 and a button 508 are displayed below the area 501.

Note that the button 506 is displayed only on the screen of the owner. Furthermore, the input field 507 and the button 508 are not displayed before the button 506 is pressed.

The input field 507 is used to input a reply to a related question in the individual display field AS.

In this manner, in the individual display field AS, a related question and the input field 507 for a reply to the related question are displayed next to one another in the vertical direction. As a result, the owner can input a reply while confirming the contents of the related question.

The button 508 is a button for posting an input related question. For example, when the button 508 is pressed, a reply input in the input field 507 is confirmed and posted.

FIG. 11 illustrates an example of display contents in a case where the button 504 is pressed after the reply is posted in the individual display field AS of FIG. 10. Note that parts corresponding to those in FIG. 10 are denoted by the same reference numerals, and the description thereof will be omitted as appropriate.

When the button 504 in FIG. 10 is pressed, a button group 504A is displayed instead of the button 504. The button group 504A is used to input a rating of a related question in the individual display field AS.

For example, the owner can give a rating of “review” to the related question by pressing a button of the button group 504A on which characters of “review” are displayed. The owner can give a rating of “normal” to the related question by pressing a button of the button group 504A on which characters of “normal” are displayed. The owner can give a rating of “important” to the related question by pressing a button of the button group 504A on which characters of “important” are displayed.

For example, the owner assigns a rating “important” to a related question that may be important to solve the root issue. For example, the owner gives a rating “review” to a related question that cannot be answered immediately and needs review.

Furthermore, for example, in the tree diagram, the display mode (such as color) of each node changes on the basis of the rating of the related question. As a result, the owner and a general user can easily recognize the owner's rating for the related question.

In this manner, the owner can easily organize his/her thoughts by assigning a rating to each related question, and classifying and organizing the questions. Furthermore, for example, the owner can quickly search for an important related question or a related question that needs review. This allows the owner to solve the root issue more quickly.

Furthermore, for example, a general user can easily recognize an important related question for the owner or a related question that needs review. This enables, for example, a general user to post more effective related questions for the owner.

Furthermore, after a reply to a related question is posted, information regarding the posted reply is displayed in an area 531 below the area 501. Specifically, characters “A:” indicating a reply are displayed in the upper left corner of the area 531. Although not illustrated, a text indicating the contents of the reply is displayed with the position where characters “answer 3” are displayed in the area 531 as the head. The posted date and time of the reply is displayed in the lower right corner of the area 531.

In this manner, in the individual display field AS, a related question and a reply to the related question are displayed next to one another in the vertical direction. As a result, the user can easily grasp the relationship between the related question and the reply.

A thumbnail 532 (indicated by circle in FIG. 11) representing the user (hereinafter referred to as replying person) who has posted the reply is displayed on the left side of the area 531. Note that except for a special case to be described later, since the replying person is basically the owner, the thumbnail 532 of the owner is displayed.

Buttons 533 and 534 are displayed in the upper right corner of the area 531.

The button 533 is a button for editing the reply displayed in the area 531. When the button 533 is pressed, the reply displayed in the area 531 becomes editable. Note that the button 533 is enabled only on the screen of the owner, for example.

The button 534 is a button for locking posting of a related question. When the button 534 is pressed, posting of a related question to the related question in the individual display field AS is restricted. For example, posting of a related question of a lower hierarchy than the related question in the individual display field AS is prohibited.

For example, if the owner determines that there is no need for further questions, the owner can prevent useless related questions from being posted by locking posting of related questions to specified related questions.

Note that when the button 534 is pressed again, posting of a related question is unlocked. Furthermore, the button 534 is enabled only on the screen of the owner, for example.

A button 535 is displayed at the lower left of the area 531. The button 535 is used in a case where a related question for the related question in the individual display field AS is posted. The remaining number of the unanswered question frame in the thread is displayed on the right of the button 535.

Note that in a case where the remaining number of the unanswered question frame in the thread is zero, for example, the button 535 is disabled. That is, posting of new related questions is restricted.

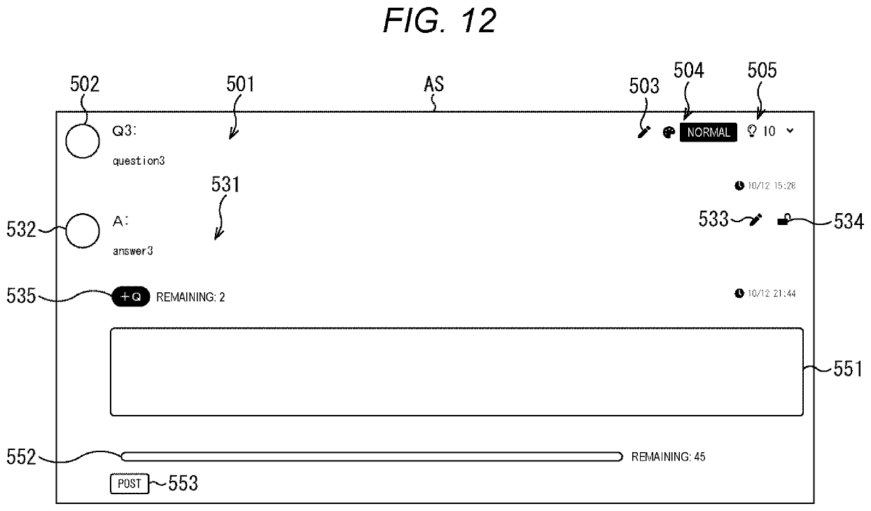

FIG. 12 illustrates an example of display contents in a case where the button 535 is pressed in the individual display field AS of FIG. 11. Note that parts corresponding to those in FIG. 11 are denoted by the same reference numerals, and the description thereof will be omitted as appropriate.

When the button 535 in FIG. 11 is pressed, an input field 551, a progress bar 552, and a button 553 are displayed below the area 531. The same applies to a case where the button 454 (FIG. 9) of a node of a related question in the individual display field AS is pressed in the tree diagram.

The input field 551 is used to input a related question for a related question in the individual display field AS.

In this manner, in the individual display field AS, a related question, a reply to the related question, and the input field 551 for a related question to the related question are displayed next to one another in the vertical direction. As a result, the user can input a related question while confirming the contents of the related question and the reply.

The progress bar 552 indicates the number of characters of the related question input in the input field 551. The remaining number of characters that can be input is displayed on the right of the progress bar 552.

Here, for example, the number of characters of the root issue and the related question is limited. In this example, the number of characters in the root issue and the related question is limited to a maximum of 45 characters.

As a result, for example, redundant questions are prevented from being posted, and the posted questions can be briefly summarized. This allows the owner to clearly understand and reply to the questions. Furthermore, the owner and general users can understand the question clearly, and can ask additional questions easily.

Note that the upper limit value of the number of characters of the solution to the root issue and the reply to the related question is set to a sufficiently large value.

The button 553 is a button for posting the related question input in the input field 551. When the button 553 is pressed, the related question input in the input field 551 is confirmed and posted. At this time, a new individual display field AS different from the individual display field AS of FIG. 12 is displayed, and a newly posted related question is displayed in the new individual display field AS.

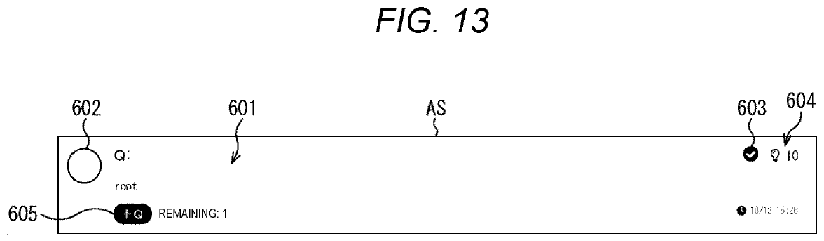

FIGS. 13 and 14 illustrate examples of display contents on the screen of the owner of the individual display field AS corresponding to the root issue.

FIG. 13 illustrates an example of the display contents of the individual display field AS before inputting a solution to the root issue.

Information regarding the root issue is displayed in an area 601. Specifically, characters “Q:” indicating the root issue are displayed in the upper left corner of the area 601. Although not illustrated, a text indicating the contents of the root issue is displayed with the position where characters “root” are displayed in the area 601 as the head. The posted date and time of the root issue is displayed in the lower right corner of the area 601.

A thumbnail 602 (indicated by circle in FIG. 13) representing the owner (person who posted root issue) is displayed in the upper left corner of the individual display field AS.

Buttons 603 and 604 are displayed in the upper right corner of the individual display field AS.

The button 603 is a button for giving a solution to the root issue and solving the root issue. When the button 603 is pressed, the individual display field AS changes as illustrated in FIG. 14 to be described later. Note that the button 603 is enabled only on the screen of the owner, for example.

The button 604 is a button similar to the button 505 in FIG. 10, and is a button for giving a high rating to the root issue.

A button 605 is displayed at the lower left of the area 601. The button 605 is a button for inputting a related question for the root issue. When the button 605 is pressed, an input field and a button similar to the input field 507 and the button 508 in FIG. 10 are displayed below the area 601 of the individual display field AS. The same applies to a case where the button 454 (FIG. 9) of the root node is pressed in the tree diagram.

FIG. 14 illustrates an example of display contents when the button 603 is pressed in the individual display field AS of FIG. 13. Note that parts corresponding to those in FIG. 13 are denoted by the same reference numerals, and the description thereof will be omitted as appropriate.

When the button 603 in FIG. 13 is pressed, an input field 631, a radio button 632, and a button 633 are displayed below the area 601.

The input field 631 is used to input a solution to the root issue.

As described above, in the individual display field AS, a root issue and the input field 631 for a solution to the root issue are displayed next to one another in the vertical direction. As a result, the owner can input a solution while confirming the contents of the root issue.

The radio button 632 is used to input the owner's emotion at the time of giving the solution. For example, the owner can select an emotion at the time of giving the solution from satisfaction, normal, and dissatisfaction.

The button 633 is used to post the solution input in the input field 631. When the button 633 is pressed, the solution input in the input field 631 is confirmed and posted.

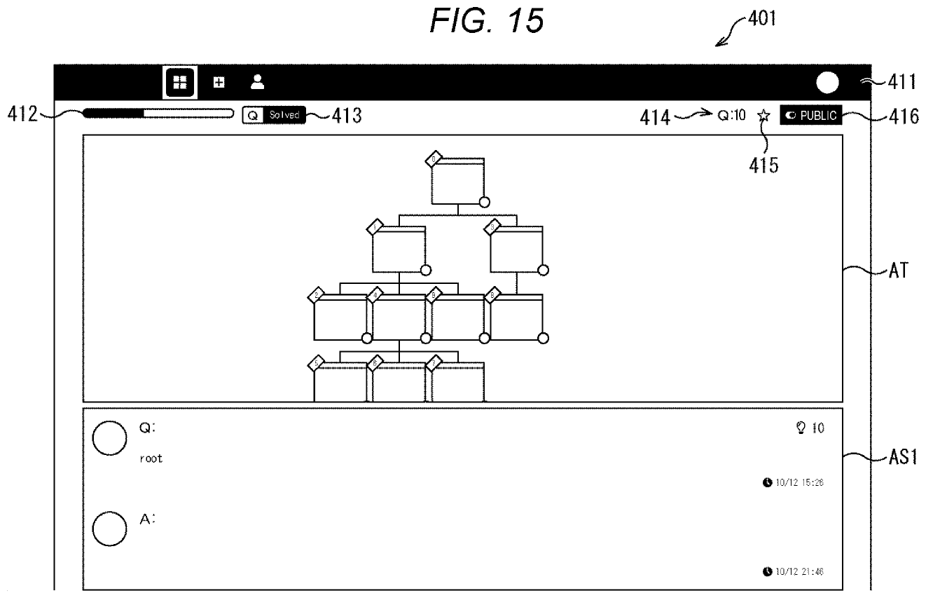

FIG. 15 illustrates an example of display contents of the window 401 when the button 633 of FIG. 14 is pressed. Note that parts corresponding to those in FIG. 6 are denoted by the same reference numerals, and the description thereof will be omitted as appropriate.

For example, the display contents of the button 413 is changed from the remaining number of the unanswered question frame to a character string “solved” indicating that the root issue has been solved.

Furthermore, although not illustrated, the solution to the root issue is displayed below the character string “A:” in an individual display field AS1 corresponding to the individual display field AS in FIG. 15. At this time, the input field 631, the radio button 632, and the button 633 in the individual display field AS1 of FIG. 14 are deleted.

In this manner, in the individual display field AS, the root issue and the solution to the root issue are displayed next to one another in the vertical direction.

As described above, the owner can post a root issue, a related question, a solution to the root issue, and a reply to a related question. A general user (owner's followee) can post a related question to the root issue and a related question. Furthermore, the owner and a general user can view the root issue, a related question, a solution to the root issue, and a reply to a related question.

<Configuration Example of Database>

Next, a configuration example of a database stored in the DB 104 of the server 11 will be described.

The DB 104 stores, for example, a thread DB. The thread DB is a database that stores data regarding a thread for each root issue.

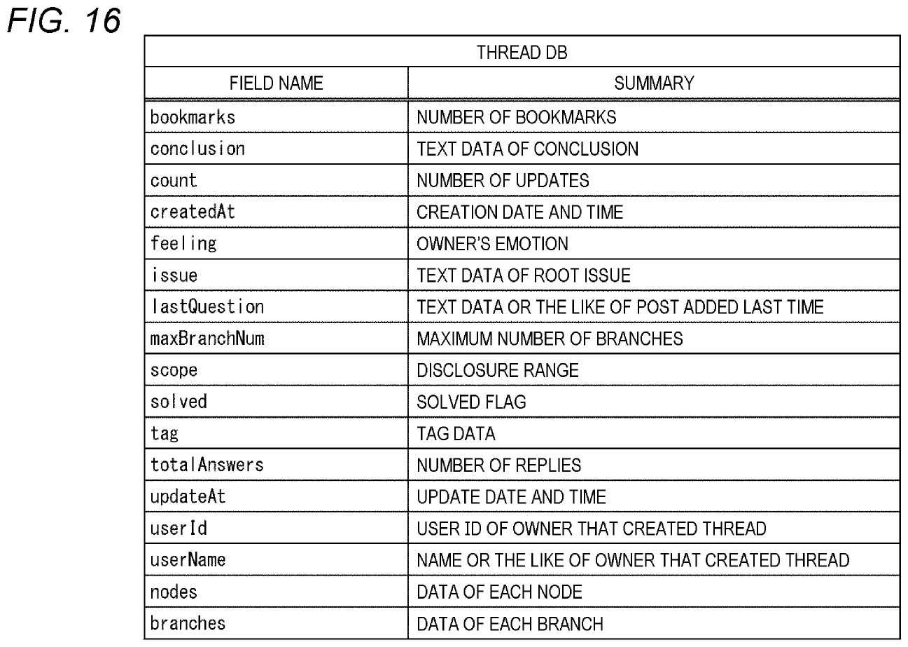

FIG. 16 illustrates a configuration example of the thread DB. The thread DB includes fields of bookmarks, conclusion, count, createdAt, feeling, issue, lastQuestion, maxBranchNum, scope, solved, tag, totalAnswers, updateAt, userId, userName, nodes, and branches.

The bookmarks field stores the number of bookmarks, that is, the number of users who have bookmarked the thread.

The conclusion field stores text data indicating a conclusion, that is, the contents of solution to the root issue.

The count field stores the number of thread updates.

The createdAt field stores the creation date and time of the thread, in other words, the posting date and time of the root issue.

The feeling field stores data indicating the emotion of the owner. That is, data indicating the emotion of the owner at the time of giving a conclusion to the root issue input by the radio button 632 in FIG. 14 is stored.

The issue field stores text data indicating the contents of the root issue.

The lastQuestion field stores text data or the like indicating the contents of the post (root issue, related question, or reply) added to the thread last time is stored (posted most recently).

The maxBranchNum field stores the maximum number of branches. The maximum number of branches is the maximum number of related questions that can be posted for one question (including root issue). For example, when the maximum number of branches is set to three, the number of related questions that can be posted for one question is limited to three. Therefore, in the tree diagram, the number of child nodes branched from one parent node is limited to three.

The scope field stores data indicating the disclosure range of the thread.

The solved field stores a flag indicating whether or not the root issue has been solved.

The tag field stores tag data set for the root issue or the thread.

The totalAnswers field stores the total number of replies posted in the thread.

The updateAt field stores the update date and time of the thread.

The userId field stores the owner who created the thread, in other words, a user ID of the owner who posted the root issue.

The userName field stores the owner who created the thread, in other words, the name or nickname of the owner who posted the root issue.

The nodes field stores data regarding each node of the tree diagram of the thread.

The branches field stores data regarding each branch (link) of the tree diagram of the thread.

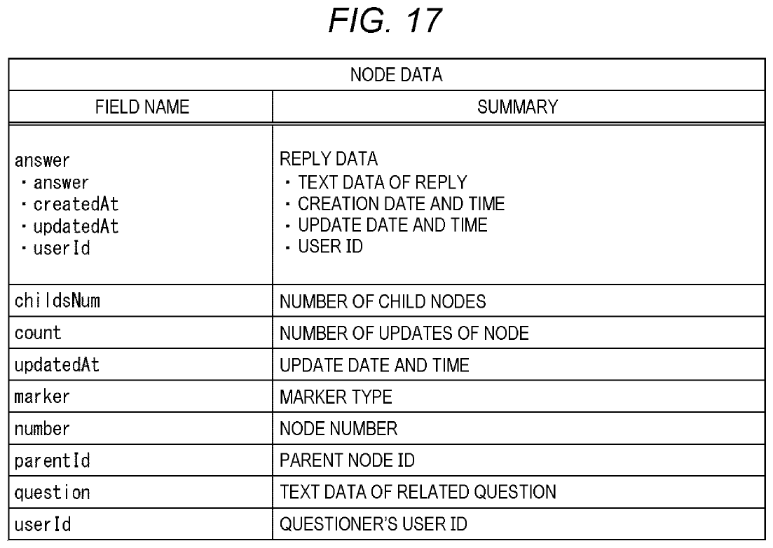

FIG. 17 illustrates a configuration example of node data stored in the nodes field of the thread DB of FIG. 16. The node data includes fields of answer, childsNum, count, updatedAt, marker, number, parentld, question, and userId.

The answer field stores data regarding a reply to a related question of a target node. For example, text data indicating reply contents, creation date and time, update date and time, and the user ID of the replying person are stored.

The childsNum field stores the number of child nodes, in other words, the number of questions posted for a question of the target node.

The count field stores the number of times of updating of related questions and the like of the target node.

The updatedAt stores the update date and time of the related questions and the like of the target node.

In the marker, data indicating a marker of a related question of the target node is stored. Here, the marker is a rating given to a related question by the above-described button group 504A of FIG. 11.

The number field stores the node number, that is, the question number of a related question of the target node.

The parentId field stores the ID of the parent node, that is, the question number of a question (root issue or related question) of the parent node.

The question field stores text data of a related question of the target node.

The userId field stores the user ID of the questioner of a related question of the target node.

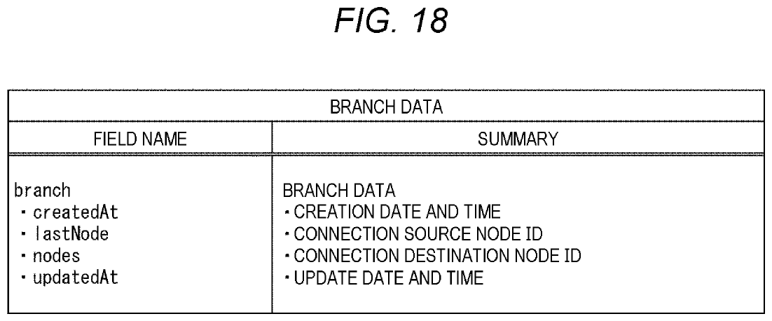

FIG. 18 illustrates a configuration example of branch data stored in the branches field of the thread DB of FIG. 16. The branch data includes a branch field.

The branch field stores a link creation date and time, a connection source node ID of a link, a connection destination node ID of a link, and a link update date and time. For example, a question number of a question (root issue or related question) of a parent node among nodes connected by a link is set as the connection source node ID of the link. For example, a question number of a related question of a child node among the nodes connected by the link is set as the connection destination node ID of the link.

Furthermore, the DB 104 stores, for example, a user DB. The user DB is a database that stores data regarding each user who uses the Q & Q service.

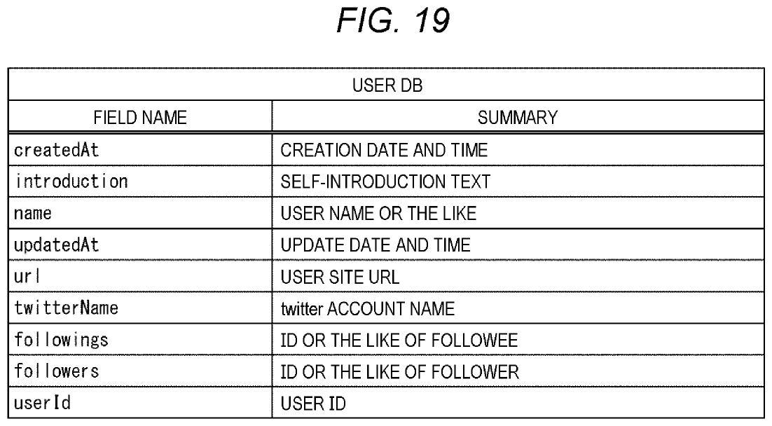

FIG. 19 illustrates a configuration example of the user DB. The user DB includes fields of createdAt, introduction, name, updatedAt, url, twitterName, followings, followers, and userId.

The createdAt field stores the creation date and time of the user account.

The introduction field stores a self-introduction text of the user.

The name field stores the name or nickname of the user.

The updatedAt field stores the update date and time of user information.

The url field stores a uniform resource locator (URL) of a site related to the user.

The TwitterName field stores the user's Twitter account name.

The followings field stores the user ID or the like of a user (followee) followed by the user.

The followers field stores the user ID or the like of a user (follower) following the user.

The userId field stores the user ID of the user.

<Automatic Response Processing>

Next, automatic response processing performed by the server 11 will be described.

Here, automatic response processing is processing in which the server 11 presents an appropriate solution or question to a root issue posted by the owner and leads the root issue to solution.

In step S1, the UI control unit 131 receives a post of a root issue.

For example, the owner inputs the root issue using the user terminal 12 by the above-described method.

The communication unit 209 of the user terminal 12 transmits data including the input root issue to the server 11 under the control of the communication control unit 232.

On the other hand, the communication unit 107 of the server 11 receives the data including the root issue input by the owner under the control of the communication control unit 135. The communication unit 107 supplies the received data to the CPU 101.

In step S2, the response unit 133 determines whether or not there has been a similar root issue in the past. Specifically, the response unit 133 searches for a root issue (hereinafter referred to as similar issue) similar to the posted root issue in the thread DB stored in the DB 104.

Note that a method of searching for similar issues is not particularly limited. For example, keywords are extracted from each root issue posted in the past, and the keywords are compared to search for similar issues.

If the response unit 133 determines that there is a similar issue as a result of the search, the processing proceeds to step S3.

In step S3, the response unit 133 determines whether or not the root issue is an issue that can be immediately solved.

Specifically, the response unit 133 determines, on the basis of at least one of the feature of the similar issue or the feature of the owner, whether or not the issue is a root issue that can be immediately solved, in other words, whether or not the issue is a root issue that can be solved without posting a related question.

For example, the response unit 133 determines whether or not the issue is a root issue that can be immediately solved on the basis of the solution rate of a similar issue. The solution rate of a similar issue is a ratio of the number of root issues that have been solved at the present time among the total number of similar issues. For example, in a case where the solution rate of the similar issue is equal to or greater than a predetermined threshold, the response unit 133 determines that the issue is a root issue that can be immediately solved. On the other hand, in a case where the solution rate of the similar issue is less than the predetermined threshold, the response unit 133 determines that the root issue cannot be immediately solved.

For example, the response unit 133 determines whether or not the issue is an immediately solvable root issue on the basis of the feature of a tree diagram of a thread including a solved similar issue. For example, the response unit 133 calculates an average number (hereinafter referred to as average number of solved questions) of nodes in tree diagrams of threads including solved similar issues and an average value (hereinafter referred to as average depth of solved questions) of depths of the tree diagrams.

For example, in a case where the average number of solved questions is less than a predetermined threshold, that is, in a case where the number of questions until the similar issue is solved is small, the response unit 133 determines that the root issue can be immediately solved. On the other hand, in a case where the average number of solved questions is equal to or greater than the predetermined threshold, that is, in a case where the number of questions until the similar issue is solved is large, the response unit 133 determines that the root issue cannot be immediately solved.

For example, in a case where the average depth of solved questions is less than a predetermined threshold, that is, in a case where no further questions are necessary for solving the similar issue, the response unit 133 determines that the root issue can be immediately solved. On the other hand, in a case where the average depth of solved questions is equal to or greater than the predetermined threshold, that is, in a case where further questions are necessary for solving the similar issue, the response unit 133 determines that the root issue cannot be immediately solved.

For example, the response unit 133 determines whether or not the issue is a root issue that can be immediately solved on the basis of time-series information of a thread of a solved similar issue. For example, the response unit 133 calculates an average value (hereinafter referred to as average solution time) of the time required to solve the solved similar issues. In a case where the average solution time is less than a predetermined threshold, that is, in a case where the time until the similar issue is solved is short, the response unit 133 determines that the root issue can be immediately solved. On the other hand, in a case where the average solution time is equal to or greater than the predetermined threshold, that is, in a case where the time until the similar issue is solved is long, the response unit 133 determines that the root issue cannot be immediately solved.

For example, the response unit 133 calculates the average number of solved questions, the average depth of solved questions, and the average solution time of the solved root issues among the root issues posted by the owner. On the basis of at least one of the average number of solved questions, the average depth of solved questions, or the average solution time, the response unit 133 adjusts a threshold used for determination processing of the above-described resolution rate of similar issues, average number of solved questions, average depth of solved questions, or average solution time.

For example, in a case where the calculated average number of solved questions is less than the predetermined threshold, that is, in a case where the owner tends to solve the root issue before replying to many questions, the response unit 133 adjusts the threshold such that it is easily determined that the root issue is a root issue that can be immediately solved. On the other hand, in a case where the calculated average number of solved questions is equal to or greater than the predetermined threshold, that is, in a case where the owner tends to solve the root issue after replying to many questions, the response unit 133 adjusts the threshold such that it is difficult to determine that the root issue is a root issue that can be immediately solved.

For example, in a case where the calculated average number of solved questions depth is less than a predetermined threshold, that is, in a case where the owner tends to solve the root issue before considering further questions, the response unit 133 adjusts the threshold such that it is easily determined that the root issue is a root issue that can be immediately solved. On the other hand, in a case where the calculated average number of solved questions is equal to or greater than the predetermined threshold, that is, in a case where the owner tends to solve the root issue after considering further questions, the response unit 133 adjusts the threshold such that it is difficult to determine that the root issue is a root issue that can be immediately solved.

For example, in a case where the calculated average solution time is less than a predetermined threshold, that is, in a case where the owner tends to solve the root issue in a short time, the response unit 133 adjusts the threshold so that it is easily determined that the root issue is a root issue that can be immediately solved. On the other hand, in a case where the calculated average solution time is equal to or greater than the predetermined threshold, that is, when the owner tends not to solve the root issue in a short time, the response unit 133 adjusts the threshold so that it is difficult to determine that the root issue is a root issue that can be immediately solved.

Note that the above-described determination conditions can be arbitrarily combined.

Then, if it is determined that the question is not an immediately solvable question, the processing proceeds to step S4.

On the other hand, if it is determined in step S2 that there have not been any similar root issues in the past, the processing in step S3 is skipped, and the processing proceeds to step S4.

In step S4, the server 11 posts a related question.

For example, the response unit 133 controls posting of a related question on the basis of at least one of a feature of a question (hereinafter referred to as question of interest) for which a new related question is to be posted, a feature of a reply to the question of interest, a feature of a question related to the question of interest, a feature of a thread including a similar issue, a feature of a thread including a root issue posted by the owner in the past, a feature of the owner, or the like.

Specifically, first, the response unit 133 selects a question of interest. For example, in a case where only the root issue has been posted in the thread to be processed (hereinafter referred to as current thread), the response unit 133 selects the root issue as the question of interest. On the other hand, in a case where a related question other than the root issue is posted, the response unit 133 selects a question of interest from the root issue and the related question.

Here, an example of a method of selecting the question of interest will be described.

For example, if a similar issue of the current root issue existed in the past, the response unit 133 selects the question of interest on the basis of a feature of the tree diagram of the thread that includes the solved similar issue.

For example, in a case where the tree diagram of solved similar issues tends to spread in the horizontal direction, the response unit 133 selects the question of interest so that the tree diagram of the current root issue spreads in the horizontal direction. That is, the response unit 133 selects the question of interest so as to widen the range of questions for the current root issue.

For example, in a case where the tree diagram of solved similar issues tends to extend in the vertical direction, the response unit 133 selects the question of interest so that the tree diagram of the current root issue extends in the vertical direction. That is, the response unit 133 selects the question of interest so as to deepen the questions for the current root issue.

For example, the response unit 133 selects the question of interest according to the order in which the tree diagram of the solved similar issues is branched.

For example, the response unit 133 selects the question of interest on the basis of a feature of the tree diagram of a thread including a solved root issue among root issues posted by the owner in the past.

For example, if the tree diagram of a solved root issue of the owner tends to spread horizontally, the response unit 133 selects the question of interest so that the tree diagram of the current root issue spreads horizontally. That is, the response unit 133 selects the question of interest so as to widen the range of questions for the current root issue.

For example, if the tree diagram of a solved root issue of the owner tends to extend vertically, the response unit 133 selects the question of interest such that the tree diagram of the current root issue extends vertically. That is, the response unit 133 selects the question of interest so as to deepen the questions for the current root issue.

For example, the response unit 133 selects the question of interest according to the order in which the tree diagram of the solved root issue of the owner is branched.

Note that the above methods for selecting a question of interest can be arbitrarily combined.

Next, the response unit 133 generates a related question for the question of interest.

Here, an example of a related question generation method will be described.

For example, the response unit 133 generates a related question on the basis of at least one of a feature of the question of interest, a feature of a reply to the question of interest, a feature of a question related to the question of interest, a feature of a thread including a similar issue, a feature of a thread including a past root issue of the owner, a feature of the owner, or the like.

Specifically, for example, in a case where there is a question similar to the question of interest in another thread, the response unit 133 generates a related question on the basis of a question of the parent node and a question of the child node in the tree diagram including the similar question. For example, in a case where the question is based on a question of a parent node of a similar question, a question obtained by abstracting the question of interest is likely to be generated. On the other hand, for example, in a case where the question is based on a question of a child node of a similar question, a question embodying the question of interest is likely to be generated.

For example, in a case where there is another question associated with the question of interest by an anchor function, the response unit 133 generates a related question on the basis of the other question, a question of a parent node of the other question, and a question of a child node of the other question.

For example, the learning unit 132 performs natural language processing on questions posted in the past, and classifies the type of each question into one of 5W1H (Who, When, Where, What, Why, How) and a closed question. Furthermore, the learning unit 132 learns the tendency of the type of question to be posted for each question for each type of question. That is, the learning unit 132 learns the tendency of the type of question posted for each of the 5W1H (Who, When, Where, What, Why, How) and a closed question.

The response unit 133 sets the type of related question to be posted on the basis of the learning result and the type of the question of interest. This facilitates generation of a type of related question that is likely to be posted for the type of the question of interest.

For example, the response unit 133 extracts a keyword from the question of interest and estimates an attribute of the question of interest (such as genre and the like) on the basis of the extracted keyword. The response unit 133 generates a related question on the basis of the attribute of the question of interest.

For example, in a case where the owner's reply is posted to the question of interest, the response unit 133 generates a related question on the basis of the owner's reply. For example, the response unit 133 generates a related question related to the contents of the owner's reply.

For example, the learning unit 132 learns features of the owner's reply to a related question. The response unit 133 generates a related question on the basis of the features of the owner's reply to a related question.

For example, in a case where the average number of characters of the owner's reply is less than a predetermined threshold, for example, in a case where the owner's reply tends to be simple, the response unit 133 generates a question for which a simple answer is assumed. On the other hand, for example, in a case where the average number of characters of the owner's reply is equal to or greater than a predetermined threshold, for example, in a case where the owner's reply tends to be detailed, the response unit 133 generates a related question for which a detailed answer is assumed.

For example, the response unit 133 generates a related question including a keyword included in the reply of the owner of the current thread or a related question related to the keyword.

For example, the response unit 133 generates a related question on the basis of a rating of the owner's related question. For example, the response unit 133 generates a related question on the basis of a feature of a related question (hereinafter referred to as important question) rated “important” by the owner in the past. For example, the response unit 133 generates a related question similar to the important question, a related question using an expression close to the expression of the important question, a related question including a keyword in the important question, and the like.

For example, the learning unit 132 analyzes a feature (such as personality, preference, ability, and the like) of the owner on the basis of contents, phrases, and the like of questions and replies of the owner in the past. The response unit 133 generates a related question on the basis of the feature of the owner.

For example, the response unit 133 generates a question suitable for the owner's personality so that the owner can easily reply to the question. For example, the response unit 133 generates a question in a sentence form suitable for the personality of the owner.

For example, the response unit 133 generates a question suitable for the owner's preference so that the owner can easily reply to the question. For example, the response unit 133 generates a question including a favorite genre or keyword of the owner. For example, on the contrary, the response unit 133 generates a question different from the owner's preference in order to stimulate the owner.

For example, the response unit 133 generates a question suitable for the ability of the owner so that the owner can easily reply to the question. For example, the response unit 133 generates a question within a range that can be understood by the owner. For example, the response unit 133 generates a question including a genre or a keyword that the owner is good at. For example, the response unit 133 generates a question slightly exceeding the ability of the owner in order to extend the ability of the owner.

Furthermore, for example, the response unit 133 generates a related question on the assumption of a person who actually exists, a person who existed in the past, or a fictitious person as the questioner of the related question. For example, a famous person, a past great person, a character or the like of a movie or a novel, or the like who the owner likes or respects is assumed as the questioner.

For example, the response unit 133 generates a related question reflecting an idea and personality of the questioner on the basis of information regarding the assumed questioner. For example, the response unit 133 generates a related question based on a thought pattern of the questioner or a related question simulating the tone or style of the questioner. This can motivate the owner to solve the root issue.

Note that the above related question generation methods can be arbitrarily combined.

Next, the UI control unit 131 controls the user terminal 12 of the owner to post the related question. That is, the UI control unit 131 causes the display unit 106 of the user terminal 12 to display the generated related question.

At this time, the response unit 133 controls the timing of posting the related question. Hereinafter, an example of a method of controlling the timing of posting the related question will be described.

For example, the response unit 133 controls the timing of posting the related question so that the posting interval is constant.

For example, the response unit 133 controls the timing of posting the related question so as to post the related question immediately after the owner answers an unanswered related question or after lapse of a predetermined time.

For example, the response unit 133 controls the timing of posting the related question on the basis of time-series information of a thread including a solved similar issue. For example, the response unit 133 controls the timing of posting the related question on the basis of a feature (such as average post interval or actual post interval) of the posting timing of related questions in the thread.

For example, the response unit 133 controls the timing of posting the related question on the basis of time-series information of a thread including a solved root issue of the owner. For example, the response unit 133 controls the timing of posting the related question on the basis of a feature (such as average post interval or actual post interval) of the posting timing of related questions in the thread.

Note that the above method of controlling the post timing can be arbitrarily combined.

Furthermore, for example, in a case where a related question is posted assuming the questioner, the UI control unit 131 may display a thumbnail using a face photograph or an illustration of the assumed questioner.

In step S5, the response unit 133 receives a reaction to the related question.

For example, the owner inputs a reply to an unanswered related question including a newly posted related question using the user terminal 12 by the above-described method as necessary. For example, the owner inputs a solution to the root issue using the user terminal 12 by the above-described method as necessary. For example, the owner inputs a question for the root issue or a related question using the user terminal 12 by the above-described method as necessary.

In a case where the above input is made by the owner, the communication unit 209 of the user terminal 12 transmits the input data to the server 11 under the control of the communication control unit 232.

In response to this, the communication unit 107 of the server 11 receives data input by the owner under the control of the communication control unit 135. The communication unit 107 supplies the received data to the CPU 101.

In step S6, the response unit 133 determines whether or not the root issue has been solved. If the solution to the root issue has not yet been posted, the response unit 133 determines that the root issue has not yet been solved, and the processing returns to step S4.

Thereafter, the processing of steps S4 to S6 is repeatedly performed until it is determined in step S6 that the root issue has been solved.

On the other hand, in step S6, when the solution to the root issue is posted, the response unit 133 determines that the root issue has been solved, and the automatic response processing ends.

Furthermore, if it is determined in step S3 that the question can be immediately solved, the processing proceeds to step S7.

In step S7, the server 11 presents the solution.

First, the response unit 133 generates a solution to the root issue. For example, the response unit 133 generates a solution to the root issue on the basis of to solution to a solved similar issue. For example, the response unit 133 searches for a website on which a solution to the root issue is presented, and generates information including the URL of the searched website as the solution.

Next, the UI control unit 131 controls the user terminal 12 of the owner to display the generated solution on the display unit 106 of the user terminal 12.

Thereafter, the automatic response processing ends.

In this manner, the server 11 automatically presents appropriate related questions to the owner, so that the owner can be guided to quickly solve the root issue.

Note that other users may also be allowed to post related questions in parallel with the server 11.

As described above, the user can organize or deepen his/her own thought by repeating replies to related questions related to the root issue. As a result, the user can draw out his/her own creativity, and can solve the root issue on the basis of the drawn creativity.

Furthermore, since the root issue and the related questions are displayed in two types of forms of tree display and individual display, the user can view the questions from different viewpoints. Furthermore, the user can easily access each question and reply. As a result, for example, the user can hierarchize his/her own thoughts or analyze his/her own thoughts from different viewpoints. This makes it easier to draw out the user's creativity.

<Example of Business Model of Q & Q Service>

Here, a specific example of the Q & Q service will be described.

For example, a business model is assumed in which an advertisement is posted on a Q & Q service screen and an advertisement posting fee or the like is charged to an advertiser.

In this case, for example, the server 11 or the advertiser may post a related question regarding a product, a service, or the like of the advertiser in an appropriate situation and timing. Furthermore, for example, the advertiser may serve as an owner, post a root issue regarding his/her own product, service, or the like, and solve the root issue with reference to related questions from the user.

As a result, the advertiser can appeal its own product, service, or the like in a more natural manner.

For example, a business model of charging a user for a Q & Q service is assumed. In this case, for example, each user may be charged for a predetermined usage amount. Furthermore, for example, the owner of each thread may disclose all or a part of the thread only to the user who has paid the charge.

For example, a business model is assumed in which coaching using the Q & Q service is performed on a user and the user is charged for a coaching fee.

In this case, for example, the recommendation unit 134 of the server 11 selects and recommends, from among coaches or other users who have a contract in advance, a coach as a candidate for a followee that posts related questions to the root issue of the user.

For example, the recommendation unit 134 recommends a coach who is compatible with the user and has ability necessary for coaching the user on the basis of the ability, preference, personality, and attribute (age, sex, nationality, and the like) of the user and the ability, preference, personality, attribute, and the like of the coach. In this case, for example, the learning unit 132 can learn the ability, preference, personality, and the like of the user on the basis of the posted contents, style, and the like of the user.

### 3. Modification

Hereinafter, modifications of the above-described embodiment of the present technology will be described.

In the above description, an example has been described in which users other than followees are restricted from posting related questions. However, for example, users other than followees can be allowed to post related questions.

In the above description, an example has been described in which posting of a related question to an unanswered related question is restricted. However, for example, posting of a related question to an unanswered related question may be permitted.

For example, the limit on the number of characters of at least one of the root issue or the related question may be eliminated.

For example, a new question may be posted above the root node so that the root issue can be changed.

For example, in a case where it is difficult for the owner to reply to the related question due to a high difficulty level of the related question or the like, the owner may be allowed to give the right of replying to the questioner of the related question. Furthermore, for example, the owner may be allowed to give the right of replying to another user (such as other followees) other than the questioner.

In this case, the user to which the right of replying is given can answer the related question instead of the owner. Furthermore, in a case where a user other than the owner has replied, a thumbnail of the actual replying person is displayed when the answer is displayed.

For example, the owner may cut out a hierarchy in the middle of the tree diagram to generate a new thread. As a result, for example, in a case where a question to be solved is found in a related question, the owner can generate a new thread having the related question as a root issue.

For example, posting of a question by the owner to a related question may be restricted. In this case, for example, the owner can only post a solution to the root issue and post a reply to a related question.

### 4. Other

The above-described series of processing may be performed by hardware or software.

Note that the program executed by the computer may be a program that performs processing in chronological order according to the order described in the present specification, or a program that performs processing in parallel, or at a necessary timing such as when a call is made.

Furthermore, in the present specification, a system means a collection of a plurality of components (devices, modules (parts), and the like), and it does not matter whether or not all the components are in the same case. Therefore, a plurality of devices accommodated in separate cases and connected through a network, and one device accommodating a plurality of modules in one case are both systems.

Moreover, the embodiment of the present technology is not limited to the above-described embodiment, and various modifications can be made without departing from the scope of the present technology.

For example, the present technology can have a cloud computing configuration in which one function is shared and processed by a plurality of devices through a network.

Furthermore, each step described in the above-described flowchart can be executed by one device or be executed in a shared manner by a plurality of devices.

Moreover, in a case where a plurality of processing is included in one step, the plurality of processing included in one step can be performed by one device or be performed in a shared manner by a plurality of devices.

<Exemplary Combination of Configuration>

The present technology can also be configured as follows.

(1)

An information processing device including
a user interface control unit that receives posting of a root issue that is a question to be solved and a related question that is a question related to the root issue, and controls display of the root issue and the related question.
   (2)

The information processing device according to (1) above, in which
the user interface control unit receives posting of a solution to the root issue from an owner who is a user who has posted the root issue, posting of a reply to the related question from the owner, and posting of the related question to the root issue or the related question from a general user who is a user other than the owner.
   (3)

The information processing device according to (2) above, in which
the user interface control unit restricts posting of the related question from the general user other than a followee who is a user followed by the owner.
   (4)

The information processing device according to (3) above, further including
a recommendation unit that recommends a user as a candidate for the followee on the basis of a feature of the owner and a feature of the user.
   (5)

The information processing device according to any one of (2) to (4) above, in which
the user interface control unit restricts posting of the related question to an unanswered related question.
   (6)

The information processing device according to any one of (2) to (5) above, in which
the user interface control unit restricts posting of a new related question in a case where the number of unanswered related questions reaches an upper limit value.
   (7)

The information processing device according to any one of (2) to (6) above, in which
the user interface control unit restricts posting of the related question to the related question specified by the owner.
   (8)

The information processing device according to any one of (2) to (7) above, in which
the user interface control unit further receives posting of the related question to the root issue or the related question from the owner.
   (9)

The information processing device according to any one of (2) to (8) above, in which
the user interface control unit controls display of a tree diagram representing a hierarchical structure of the root issue and the related question in a tree shape.
   (10)

The information processing device according to (9) above, in which
the user interface control unit controls individual display in which questions selected in the tree diagram are individually arranged next to one another together with the tree diagram.
   (11)

The information processing device according to (10) above, in which
the user interface control unit controls the individual display such that the questions selected in the tree diagram are arranged in chronological order.
   (12)

The information processing device according to (10) or (11) above, in which
in a case where a node of the root issue is selected in the tree diagram, the user interface control unit controls the individual display such that the root issue and all the related questions are individually displayed next to one another.
   (13)

The information processing device according to any one of (10) to (12) above, in which
in a case where a link between nodes in the tree diagram is selected, the user interface control unit controls the individual display such that questions of nodes existing in a path from a node of the root issue to a lower node among nodes connected to the selected link are individually displayed next to one another.
   (14)

The information processing device according to any one of (10) to (13) above, in which
in a case where a predetermined operation is performed on the tree diagram, the user interface control unit controls the individual display such that all unanswered related questions are individually displayed next to one another.
   (15)

The information processing device according to any one of (10) to (14) above, in which
the user interface control unit controls the individual display such that the related question and a reply to the related question are displayed next to one another.
   (16)

The information processing device according to any one of (10) to (15) above, in which
the user interface control unit controls the individual display such that an input field of the related question or a reply to the related question and the related question are displayed next to one another.
   (17)

The information processing device according to any one of (10) to (16) above, in which
the user interface control unit controls the individual display such that the root issue and a solution to the root issue are displayed next to one another.
   (18)

The information processing device according to any one of (10) to (17) above, in which
the user interface control unit controls the individual display such that an input field of the related question or a solution to the root issue and the root issue are displayed next to one another.
   (19)

The information processing device according to any one of (9) to (18) above, in which
the user interface control unit differentiates a display mode between a node of an unanswered related question and a node of an answered related question in the tree diagram.
   (20)

The information processing device according to any one of (9) to (19) above, in which
the user interface control unit receives input of a rating by the owner for the related question, and changes a display mode of a node of each of the related questions in the tree diagram by the rating.
   (21)

The information processing device according to any one of (2) to (20) above, further including
a response unit that posts the related question for the root issue or the related question.
   (22)

The information processing device according to (21) above, in which
the response unit controls posting of the related question on the basis of at least one of a feature of a question of interest that is a question for which the related question is to be posted, a feature of a reply to the question of interest, a feature of a question related to the question of interest, a feature of a first thread including a first root issue that is another root issue similar to the root issue, a feature of a second thread including a second root issue that is another root issue posted by the owner, or a feature of the owner.
   (23)

The information processing device according to (22) above, in which
the response unit selects the question of interest on the basis of at least one of a feature of a tree diagram representing a hierarchical structure of the first root issue and the related question in the first thread in a tree shape or a feature of a tree diagram representing a hierarchical structure of the second root issue and the related question in the second thread in a tree shape.
   (24)

The information processing device according to (22) or (23) above, in which
the response unit generates the related question on the basis of at least one of a feature of the question of interest, a feature of a reply to the question of interest, a feature of a question related to the question of interest, a feature of the first thread, a feature of the second thread, or a feature of the owner.
   (25)

The information processing device according to any one of (22) to (24) above, in which
the response unit controls a posting timing of the related question on the basis of at least one of a feature of a posting timing of the related question in the first thread or a feature of a posting timing of the related question in the second thread.
   (26)

The information processing device according to any one of (22) to (25) above, in which
the response unit posts a solution to the root issue in a case where it is determined that the root issue is solvable without posting the related question on the basis of at least one of a solution rate of the first root issue or a feature of the first thread.
   (27)

The information processing device according to any one of (21) to (26) above, in which
the response unit generates the related question assuming a person who actually exists, a person who existed in the past, or a fictitious person as a questioner of the related question.
   (28)

The information processing device according to any one of (1) to (27) above, in which
the user interface control unit limits the number of characters of the related question.
   (29)

The information processing device according to any one of (1) to (28) above, in which
the user interface control unit controls display of the root issue and the related question in another information processing device.
   (30)

An information processing method including
receiving posting of a root issue that is a question to be solved and a related question that is a question related to the root issue, and
controlling display of the root issue and the related question.
   (31)

A program for causing a computer to execute processing of
receiving posting of a root issue that is a question to be solved and a related question that is a question related to the root issue, and
controlling display of the root issue and the related question.

Note that the effect described in the present specification is merely an illustration and is not restrictive. Hence, other effects can be obtained.

### REFERENCE SIGNS LIST

1 Information processing system
11 Server
12-1 to 12-n User terminal
101 CPU
104 DB
107 Communication unit
131 UI control unit
132 Learning unit
133 Response unit
134 Recommendation unit
135 Communication control unit
201 CPU
205 Display unit
209 Communication unit
231 UI control unit
232 Communication control unit

1. An information processing device comprising a user interface control unit that receives posting of a root issue that is a question to be solved and a related question that is a question related to the root issue, and controls display of the root issue and the related question.

2. The information processing device according to claim 1, wherein
the user interface control unit receives posting of a solution to the root issue from an owner who is a user who has posted the root issue, posting of a reply to the related question from the owner, and posting of the related question to the root issue or the related question from a general user who is a user other than the owner.

3. The information processing device according to claim 2, wherein
the user interface control unit restricts posting of the related question from the general user other than a followee who is a user followed by the owner.

4. The information processing device according to claim 3, further comprising
a recommendation unit that recommends a user as a candidate for the followee on a basis of a feature of the owner and a feature of the user.

5. The information processing device according to claim 2, wherein
the user interface control unit restricts posting of the related question to an unanswered related question.

6. The information processing device according to claim 2, wherein
the user interface control unit restricts posting of a new related question in a case where the number of unanswered related questions reaches an upper limit value.

7. The information processing device according to claim 2, wherein
the user interface control unit restricts posting of the related question to the related question specified by the owner.

8. The information processing device according to claim 2, wherein
the user interface control unit further receives posting of the related question to the root issue or the related question from the owner.

9. The information processing device according to claim 2, wherein
the user interface control unit controls display of a tree diagram representing a hierarchical structure of the root issue and the related question in a tree shape.

10. The information processing device according to claim 9, wherein
the user interface control unit controls individual display in which questions selected in the tree diagram are individually arranged next to one another together with the tree diagram.

11. The information processing device according to claim wherein
the user interface control unit controls the individual display such that the questions selected in the tree diagram are arranged in chronological order.

12. The information processing device according to claim wherein
in a case where a node of the root issue is selected in the tree diagram, the user interface control unit controls the individual display such that the root issue and all the related questions are individually displayed next to one another.

13. The information processing device according to claim wherein
in a case where a link between nodes in the tree diagram is selected, the user interface control unit controls the individual display such that questions of nodes existing in a path from a node of the root issue to a lower node among nodes connected to the selected link are individually displayed next to one another.

14. The information processing device according to claim wherein
in a case where a predetermined operation is performed on the tree diagram, the user interface control unit controls the individual display such that all unanswered related questions are individually displayed next to one another.

15. The information processing device according to claim wherein
the user interface control unit controls the individual display such that the related question and a reply to the related question are displayed next to one another.

16. The information processing device according to claim wherein
the user interface control unit controls the individual display such that an input field of the related question or a reply to the related question and the related question are displayed next to one another.

17. The information processing device according to claim wherein
the user interface control unit controls the individual display such that the root issue and a solution to the root issue are displayed next to one another.

18. The information processing device according to claim wherein
the user interface control unit controls the individual display such that an input field of the related question or a solution to the root issue and the root issue are displayed next to one another.

19. The information processing device according to claim 9, wherein
the user interface control unit differentiates a display mode between a node of an unanswered related question and a node of an answered related question in the tree diagram.

20. The information processing device according to claim 9, wherein
the user interface control unit receives input of a rating by the owner for the related question, and changes a display mode of a node of each of the related questions in the tree diagram by the rating.

21. The information processing device according to claim 2, further comprising
a response unit that posts the related question for the root issue or the related question.

22. The information processing device according to claim 21, wherein
the response unit controls posting of the related question on a basis of at least one of a feature of a question of interest that is a question for which the related question is to be posted, a feature of a reply to the question of interest, a feature of a question related to the question of interest, a feature of a first thread including a first root issue that is another root issue similar to the root issue, a feature of a second thread including a second root issue that is another root issue posted by the owner, or a feature of the owner.

23. The information processing device according to claim 22, wherein
the response unit selects the question of interest on a basis of at least one of a feature of a tree diagram representing a hierarchical structure of the first root issue and the related question in the first thread in a tree shape or a feature of a tree diagram representing a hierarchical structure of the second root issue and the related question in the second thread in a tree shape.

24. The information processing device according to claim 22, wherein
the response unit generates the related question on a basis of at least one of a feature of the question of interest, a feature of a reply to the question of interest, a feature of a question related to the question of interest, a feature of the first thread, a feature of the second thread, or a feature of the owner.

25. The information processing device according to claim 22, wherein
the response unit controls a posting timing of the related question on a basis of at least one of a feature of a posting timing of the related question in the first thread or a feature of a posting timing of the related question in the second thread.

26. The information processing device according to claim 22, wherein
the response unit posts a solution to the root issue in a case where it is determined that the root issue is solvable without posting the related question on a basis of at least one of a solution rate of the first root issue or a feature of the first thread.

27. The information processing device according to claim 21, wherein
the response unit generates the related question assuming a person who actually exists, a person who existed in the past, or a fictitious person as a questioner of the related question.

28. The information processing device according to claim 1, wherein
the user interface control unit limits the number of characters of the related question.

29. The information processing device according to claim 1, wherein
the user interface control unit controls display of the root issue and the related question in another information processing device.

30. An information processing method comprising
receiving posting of a root issue that is a question to be solved and a related question that is a question related to the root issue, and
controlling display of the root issue and the related question.

31. A program for causing a computer to execute processing of
receiving posting of a root issue that is a question to be solved and a related question that is a question related to the root issue, and
controlling display of the root issue and the related question.
